(19) United States
(12) Patent Application Publication
(10) Pub. No.: US 2007/0058384 A1
(43) Pub. Date: Mar. 15, 2007

(54) Electrical energy transfer assembly for a motorcycle wheel

(76) Inventor: Mohammed John Fitzgerald Khan, Silver Spring, MD (US)

Correspondence Address: Mohammed J.F. Khan, 14813 Mistletoe Court, Silver Spring, MD, 20905, US

(21) Appl. No.: 11/224,091

(22) Filed: Sep. 13, 2005

(51) Int. Cl. B60Q 1/26

(52) U.S. Cl. 362/500

(57) ABSTRACT

A rotary electrical contact device for transferring electrical energy and control signals from a stationary point on a motorcycle to a motorcycle wheel for the purposes of powering a wheel-illuminating display device mounted on a motorcycle wheel such as that device described in U.S. Pat. No. 6,789,928, “Automatic Mechetronic Wheel Light Device”. The present device mounts inconspicuously against the hub of a motorcycle wheel, typically within the space bounded by a motorcycle wheel axel and the inner diameter of a disc brake rotor. The device allows for simultaneous electrical power transmission for multiple electrical circuits. The device comprises a combination of mechanical and electrical components and can be manufactured inexpensively using common materials. The device can be configured for all types of motorcycles types.

### CROSS-REFERENCE TO RELATED APPLICATIONS

This application relates to application Ser. No. 09/986,875, filed on Nov. 13, 2001, and issued as U.S. Pat. No. 6,789,928 on Sep. 14, 2004.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention pertains to the area of electrical energy transfer devices, particularly to the area of rotating electrical energy transfer devices for motorcycle wheels. This invention allows for the transfer of electrical energy and control signals necessary for the illumination and control of light sources as those described in U.S. Pat. No. 6,789,928, “Automatic Mechetronic Wheel Light Device”. This application discloses a new method for transferring electrical power and control signals from a stationary point on a motorcycle to light sources mounted on a motorcycle wheel. This application discloses an approach for transferring electrical power and control signals which is not suggested in U.S. Pat. No. 6,789,928 and is a marked improvement over those taught in U.S. Pat. No. 6,789,928.

### BRIEF SUMMARY OF THE INVENTION

The present invention allows for the transfer of electrical energy and control signals from a stationary electrical conductor at a fixed location on a motorcycle to a rotating wheel of the motorcycle for facilitating automatic illumination of light sources mounted on a motorcycle wheel. The present invention enables the flow of electrical current and transfer of control signals from a fixed location on a motorcycle to a rotating motorcycle wheel through the use of suitable components including an electrically non-conductive rotor, an electrically non-conductive base plate, electrical tracks, bearings, and electrical connectors. The assembly of these components forms a disc-shaped rotary electrical contact device that fits on a motorcycle wheel; the rotor and base plate sandwich the bearings and electrical tracks, and the rotor and base plate contain a hole at their centers to accommodate the motorcycle wheel axel.

Most modem motorcycles have solid-spoke wheels that accommodate disc brake assemblies. The disc brake rotors are fastened to the wheel hubs, and as in the case with most rear wheel assemblies and front wheel assemblies, particularly those using non-floating brake rotors, a sizable circular, empty space or void is formed between the outer diameter of the wheel axel and the inner diameter of the brake rotor. This space has both a radial dimension and a depth dimension and provides sufficient volume for a rotary electrical contact device. The present invention takes advantage of this available space as it fits neatly and inconspicuously within it—this is a primary advantage of the present invention over the methods discussed in U.S. Pat. No. 6,789,928. Therefore, for rear-wheel installations on motorcycles equipped with a rear disc brake, the present invention fits within the volume of space available between the radial boundaries formed by the outer diameter of the rear axel and the inner diameter of the rear disc brake rotor. For front-wheel installations on motorcycles equipped with front disc brakes, the present invention fits within the space available between the radial boundaries formed by the outer diameter of the front axel and the inner diameter of the front disc brake rotor.

To access the space between the brake rotor and wheel axel and to mount the present invention, removal of the motorcycle's wheels is required. The present invention is placed on the wheel, with its rotor component in overlying relation to the outer surface of the motorcycle wheel hub. The motorcycle wheel is reinstalled with the axle passing through the center of the present invention. All electrical connections are then made to complete the installation.

The present invention utilizes external electrical pin-type connectors located on the outside surfaces of its base plate and rotor. Input power and control signals from a stationary point on the motorcycle enter the present invention via the connectors on the base plate. Output power and control signals exit the present invention via the electrical connectors on the rotor. The wheel provides a circuit ground. Most solid-spoke motorcycle wheels of modern motorcycles have hollow hubs with holes on the side faces as well as holes on the radial surface from which the spokes attach. These holes allow for convenient routing of electrical conductor wires or cables which connect electrically-powered devices, such as a light emitting diode (LED), to the output side (rotor) of the present invention.

The present invention offers another benefit over the electrical energy transfer methods presented in U.S. Pat. No. 6,789,928. The present invention includes a dynamic seal to preclude water, oil, dirt, or other foreign debris from contaminating and shorting the components used to transfer the electrical power.

It is the object of the present invention to serve as an effective means for transferring electrical power from a fixed point on a motorcycle to an electrically powered device, including a light source, located on a motorcycle wheel.

It is also the object of the present invention to serve as an effective means for transferring control signals from a fixed point on a motorcycle to an electrically powered device, including a light source, located on a motorcycle wheel.

Yet another object of the present invention is to serve as an effective means for transferring electrical power and control signals from a fixed point on a motorcycle to an electrically powered device, including a light source, located on a motorcycle wheel in a manner which is impervious to the adverse effects of water or other foreign matter including shorting of electrical circuits and corrosion of electrical conductors.

It is further the object of the present invention to serve as an effective means for transferring electrical power from a fixed point on a motorcycle to an electrically powered device, including a light source, located on a motorcycle wheel in a manner which mounts to the hub of a motorcycle wheel to provide for an inconspicuous appearance.

### BRIEF DESCRIPTION OF THE SEVERAL VIEWS OF THE DRAWING

FIG. 1 is an “exploded” view of the present invention configured for a particular four-spoke motorcycle wheel hub with a disc brake rotor, showing how the base plate and rotor of the present invention are mutually arranged and mount concentrically to the motorcycle wheel hub and fit in the space between the disc brake rotor and the hole for the wheel axel.

FIG. 2 is a front view of the present invention showing its general circular geometry and central hole for accommodating a wheel axel.

FIG. 3 is a cross-sectional view of the present invention assembly, at cross section AA as indicated in FIG. 2, showing the construction and arrangement of the components comprising the present invention. The present invention includes at least one bearing to allow for relative motion between the rotor, base plate, and conductor tracks. The present invention also includes a sealing means to preclude contamination by water and foreign materials.

### DETAILED DESCRIPTION OF THE INVENTION

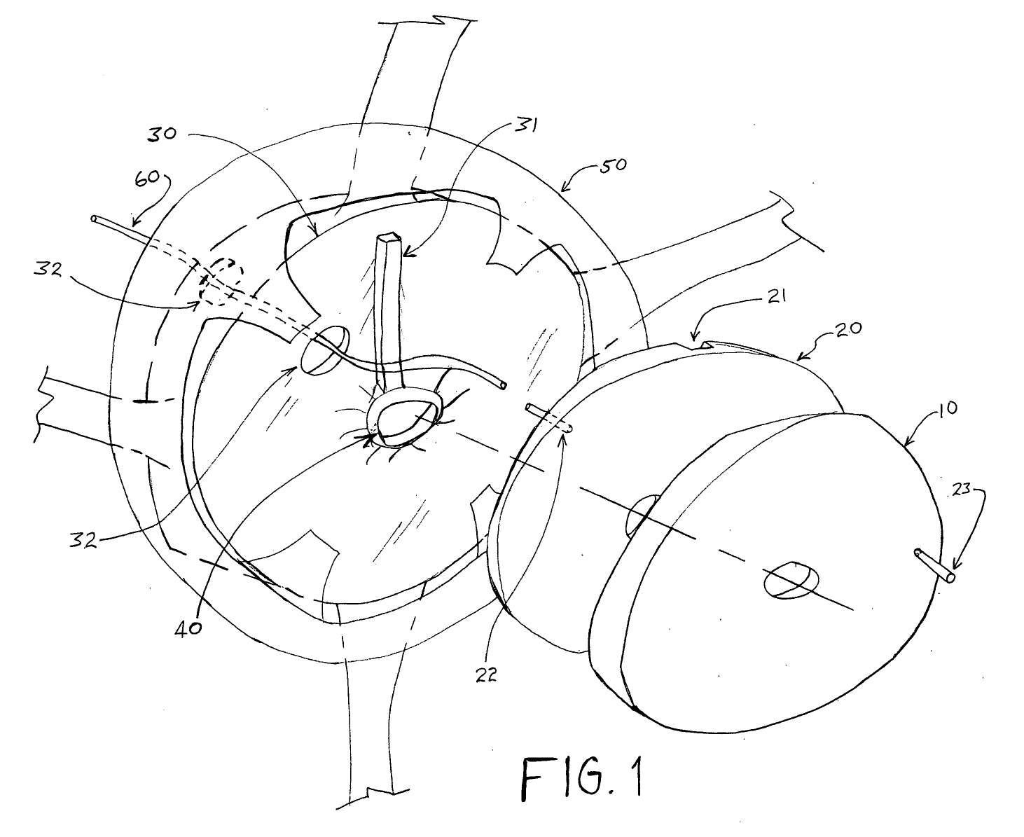

Referring to FIG. 1, base plate 10 and rotor 20 are mutually arranged and mount concentrically in the space available on the motorcycle wheel hub 30 between axel hole 40 and disc brake rotor 50. Inner surface of rotor 20 has slot 21 which mates with spline 31 on motorcycle wheel hub 30 enabling rotor 20 and motorcycle wheel hub 30 to rotate together. Wire 60 passes through hole 32 on radial surface of motorcycle wheel hub 30 and through hole 32 on side surface of motorcycle wheel hub 30 and establishes an electrical connection between a light emitting diode mounted on the outer diameter of motorcycle wheel to rotor electrical connector 22. Base plate electrical connector 23 receives input power and control signals from a point on a motorcycle.

Referring to FIG. 2, the present invention features concentrically located axel hole 41 which allows for the passage of a motorcycle wheel axle.

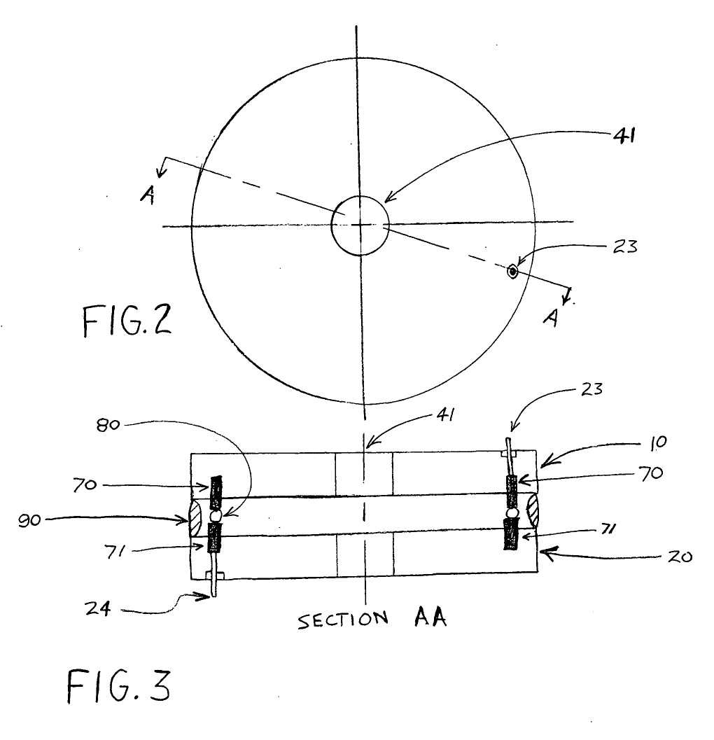

Referring to FIG. 3, base plate electrical connector 23 is fixedly mounted in base plate 10 and makes electrical contact with base plate electrical track 70 for the transmission of electrical power and control signals. Base plate electrical track 70 is preferably made of hardened steel or other suitable electrically conductive material and fixedly mounted in base plate 10. Ball bearing 80, preferably made of hardened steel or other suitable electrically conductive material, allows base plate 10 and rotor 20 to rotate relative to each other and provides pathway for the transmission of electrical power and control signals to rotor electrical track 71, which is preferably made of hardened steel or other suitable electrically conductive material. Rotor electrical track 71 is fixedly mounted in rotor 20 and makes electrical contact with rotor electrical connector 24 to complete transmission pathway for electrical current and control signals. Dynamic seal 90 prevents water, dust, and other foreign debris from contaminating electrical tracks 70 and 71 and ball bearing 80. Rotor 20 and base plate 10 have concentrically located axel hole 41.

It should be obvious to those with ordinary skill in the art that the present invention can be manufactured to accommodate multiple circuits or transmission lines, simply by increasing the number of electrical tracks. These additional tracks would have different diameters and be concentrically mounted in the rotor and in the base plate.

It should also be obvious to those skilled in the art and especially obvious to those skilled in the art with a familiarity in the design and construction of rotary electrical contacts and slip rings, that the drawings of the components of the present invention serve to illustrate only and that tangible components can take on variations and remain within the extent of the claims hereunder. For example, the present invention could function as described using electrical contact track(s) placed on either the base plate or the rotor—not placed in both the base plate and rotor as shown in FIG. 3. In lieu of an electrical track (and ball bearing) on either the base plate or rotor, a simple carbon brush or electrically-conductive “wiper” could be employed. As another example of a possible variation of the present invention, the ball bearing concept could be abandoned making the electrical tracks directly contacting each other. Yet another example of a variation of the present invention is that the electrical pathway(s) between the rotor and base plate of the present invention can be of electrically conductive liquids and utilize appropriate seals to prevent shorting of multiple transfer circuits.

It should be obvious to those with ordinary skill in the art that the present invention can include a means for preventing motion relative to a motorcycle wheel other than that depicted in FIG. 1. FIG. 1 shows a slotted rotor which mates to a spline or other convex feature on the side face of the motorcycle wheel hub. The use of fasteners, compression fitting, and cementing are examples of other methods to preclude relative motion.

Persons skilled in the art should also readily perceive how the present invention could be suitably configured (including changes in: geometry; means for electrical power transmission; mounting, fastening, and preclusion or relative motion with respect to a motorcycle wheel) for other vehicles (cars, buses, trucks, emergency response vehicles, etc.) of varying wheel and axle configurations, or made as an integrated “built-in” feature of a wheel or wheel cover without, in any manner, departing from the spirit of the present invention.

I claim:

1. An electrical energy transfer assembly for a wheel in combination with a motorcycle, said wheel having a hollow hub with holes and a designated provision for an axel, comprising:
a base plate constructed of an electrically nonconductive material;
a rotor constructed of an electrically nonconductive material;

2. The assembly of claim 1 further including:
at least one rotor ring member constructed of an electrically conductive material concentrically fixed within said rotor, and having inner and outer diameters larger than the diameter of said designated provision for an axel.

3. The assembly of claim 2, wherein said wheel is a rear wheel of a motorcycle and said motorcycle includes a rear disc brake assmbly, having dimensions whereby said base plate and said rotor can be installed in the space available within the boundaries generally formed by the outer diameter of a rear axel of said motorcycle and the inner diameter of a rear brake rotor of said rear disc brake assembly.

4. The assembly of claim 2, wherein said wheel is a front wheel of a motorcycle and said motorcycle includes a front disc brake assembly, having dimensions whereby said base plate and said rotor can be installed in the space available within the boundaries generally formed by the outer diameter of a front axel of said motorcycle and the inner diameter of a front brake rotor of said front disc brake assembly.

5. The assembly of claim 2 further comprising:
at least one base plate ring member constructed of an electrically conductive material concentrically fixed within said base plate and having inner and outer diameters matching those of said rotor ring member.

6. The assembly of claim 5 further comprising:
at least one electrically conductive ball bearing emplaced between said base plate and said rotor establishing electrical continuity between said base plate ring member and said rotor ring member.

7. The assembly of claim 6 wherein said electrical continuity is continuous for any given amount of angular displacement of said rotor relative to said base plate.

8. The assembly of claim 1 further comprising at least one means for at least one external electrical connection to said base plate.

9. The assembly of claim 1 further comprising at least one means for at least one external electrical connection to said rotor.

10. The assembly of claim 1 further comprising a means for preventing contamination from one of the group consisting of: liquid water, water vapor, oil, dirt, dust.

11. The assembly of claim 1 wherein further including at least one means for precluding a relative motion between said rotor and said wheel.

12. The assembly of claim 8 wherein said base plate includes at least one means for transferring electrical energy to said external connection to said rotor, said means for transferring including at least one of the group consisting of: contact ring, carbon brush, roller contact, ball bearing, electrically conductive fluid.
